(19) United States
(12) Patent Application Publication
(10) Pub. No.: US 2003/0202845 A1
(43) Pub. Date: Oct. 30, 2003

(54) New type joint assembly for plates

(75) Inventors: Liang-Fu Xie, Guangdong (CN); Yan-Wen Song, Guangdong (CN); Yuan-Da Zhou, Guangdong (CN)

Correspondence Address: GREENBLUM & BERNSTEIN, P.L.C., 1950 ROLAND CLARKE PLACE, RESTON, VA, 20191, US

(73) Assignee: China International Marine Containers (Group) Co., Ltd., Guangdong (CN)

(21) Appl. No.: 10/396,367

(22) Filed: Mar. 26, 2003

(30) Foreign Application Priority Data
Mar. 29, 2002 (CN) 02226551.1
Apr. 28, 2002 (CN) 02227324.7
Apr. 29, 2002 (CN) 02227396.4
Apr. 30, 2002 (CN) 02227416.2

(51) Int. Cl. F16D 1/00

(52) U.S. Cl. 403/326

(57) ABSTRACT

The present invention discloses a new type joint assembly for plates. By using this new type joint component, it is possible to complete the riveting of the plate and the joint component during the manufacturing of the plate, detachment becomes easier, so it is convenient to maintain and disassemble the carriage body. While ensuring that the carriage body of the containers or the van trailers have relatively larger interior width, the inner and outer surfaces of the entire side panels are flat or substantially flat.

### FIELD OF THE INVENTION

The present invention relates to a joint assembly for containers and van trailers, and more specifically to a joint structure used for joining plates of the roof sheet and side panels of a container or a van trailer.

### BACKGROUND OF THE INVENTION

In the prior art, a container or a van trailer consists of a roof sheet on top, a floor on the bottom, side panels on both sides, a front panel and a door panel, which form a hexahedron structure. As is known to all, the outside dimension of vehicles running on high way is limited by regulations. In order to obtain more inner space, the thickness of the side panels have to be reduced. Therefore, the side panels should be rather thin but of very high strength.

Conventional vane-type semi-trailers have side panels of a frame structure with steel or aluminum plate skin covered on its inner and outer surfaces, and the side panels normally having an integral riveted structure. The integral structure has disadvantages as: relatively thicker side panels, inconvenience for maintenance, limited interior width of the trailer body, and relatively large payload of the side panels.

At present, a frameless structure has been developed for the side panels of the carriage body of the van trailer. A side panel is jointed by a plurality of plates (at least two). No matter what method and apparatus are used to join the plates, it is required that the joint should have relatively high strength and relatively small size, and that assembling in manufacturing process, maintenance and detachment thereof should be convenient. The method and components that have been used to join plates are normally as follows.

1. Part of the joining edge of the plate is processed, punched and directly riveted with rivets.

2. Part of the edge of the plate is processed, punched with a hard filler filled in between two plates and riveted with rivets.

3. The edges of two plates are riveted with rivets by means of a joint component.

When the above-mentioned joining method and joining component are used, it is necessary to rivet and join the adjacent plates on assembling site, therefore they are time and energy consuming, and maintenance and detachment are difficult (because the plates can only be detached by taking out the joining rivets). Moreover, as the above-mentioned joint component is normally an integral structure which cannot be disassembled, it is inconvenient for assembling and maintenance operations.

Currently, the Duraplate, which is a sandwich panel developed independently by Wabash, the largest semi-trailer manufacturer in the United States, represents a trend of development. Many patents have been granted to the joining method for Duraplate sandwich panels, such as U.S. Pat. Nos. 5,066,066, 4,685,721 and 5,112,099. These U.S. patents disclosed the technology to use one or two joining members for joining the composite panels. However, the joined panels are located either on one side of the joining member or between two joining members, the inner and outer surfaces of the entire side panel of the body of van trailer are not flat enough, and it is difficult to ensure a relatively large interior width of the body of van trailer.

### SUMMARY OF THE INVENTION

The main object of the present invention is to provide a new type joint assembly for plates. By using this new type joint assembly, it is no longer necessary to conduct riveting operations at assembling site. In other words, it is possible to complete the riveting of the plate and the joint assembly during the manufacturing of the plate. Moreover, detachment becomes easier, so it is convenient to maintain and disassemble the carriage body.

Another object of the present invention is to provide a new type joint assembly for plates, while ensuring that the carriage body of the containers or the van trailers have relatively larger interior width, the inner and outer surfaces of the entire side panels of the containers or the van trailers are flat or substantially flat.

To achieve the aim of the present invention, a new type joint assembly for plates is provided, which has a separate type structure consisting of a plurality of separate joint elements. Said joint elements are preferred to be of two joint elements, includes an interior joint element and an exterior joint element having a length equal or not equal to that of the joining edges of the plates. Said interior joint element has a C-shaped inserting groove opening outwardly, said exterior joint element has an inserting groove opening inwardly and engaged with the two sides of the inserting groove of said interior joint element. Positioning mechanisms matching with each other are formed on adjacent surfaces on the two sides of the engaged inserting grooves. At least one wing for securely joining the plate of the carriage body is formed on the outer side of each of the inserting grooves.

The separate joint elements according to the present invention are assembled as follows: making the two joint elements joint with the edges of two different plates respectively, then, aligning the positioning mechanisms on the engaged inserting grooves of the two joint elements and pressing them together by external force. Thus, the two adjacent plates are joined integrally without the necessity to resort to any riveting operation.

By using the joint assembly provided by the present invention, it is possible to rivet the wings of the interior and exterior joint elements securely on joining edges of plates respectively during the manufacturing process of the plates for carriage bodies. Therefore, when assembling containers, by merely inserting to each other the inserting grooves of the interior and exterior joint elements joined to the two adjacent plates, the adjacent plates can be joined integrally through the engagement structure formed by the interior and exterior joint elements. The assembling process is easier and time-saving. When the carriage body needs to be disassembled for maintenance or repair, the plates can be detached by separating the interior and exterior joint elements with screwdrivers. Thus, maintenance and repair become easier.

To achieve the aim of the present invention, another new type joint assembly for plates is provided, which is an intermediate joining member having a T-shaped cross section jointed between two adjacent plates of the carriage body. Said intermediate joining member consists of a major wing, in the middle of the major wing is formed a vertical web to be clamped by the end surfaces of said two plates, the height of said vertical web is corresponding to the thickness of said plates, the two adjacent plates are riveted to said major wing by rivets respectively, at the end portion of said vertical web is formed a small section of minor wing turning toward one side and engaging the inner side edge of one of the plates.

This kind of joint assembly may be applied to side panels of the van trailer. By joining two adjacent sandwich panels respectively to major wings of the joining member through riveting by means of the T-shaped joint, it is possible to form a side panel of the van trailer with a plurality of sandwich panels having the same thickness. The top end of the joining member and the top end of the side panel are riveted to the top beam of the van trailer, and the bottom end and the bottom end of the side panel are riveted to the bottom side rail of the van trailer. The front end of the foremost sandwich panel is joined to the front corner post of the van trailer, and the rear end of the rearmost sandwich panel is joined to the rear corner post of the van trailer.

The joining member according to the present invention may be made of aluminum, aluminum alloy, hard plastics and other materials. In this way, the problem that the inner and outer surfaces of the side panel are not flat caused by overlapped joining of the sandwich panels is solved, and the load carrying capacity is raised. The wall panels of the carriage body of the van trailer joined by this joining member have relatively high strength and rigidity.

In the same time, this kind of joint assembly may be applied to cargo containers as well.

To achieve the aim of the present invention, another new type joint assembly for plates is provided, which is an intermediate joining member having a Z-shaped cross section jointed between two adjacent plates of the carriage body. Said Z-shaped joining member in said carriage body of van trailer consists of an inner wing, a vertical web, an outer wing and a clamping section. The inner wing and the outer wing are parallel to each other and perpendicular to the vertical web. After one of the plates is positioned on the side of the inner wing of the Z type joint, and the other plate is positioned on another side of the outer wing of the Z type joint, they are riveted to the Z type joint respectively with rivets. The two joined plates have the same thickness. In this way, it is possible to ensure that the inner and outer surfaces of the side panel formed by joining two plates to the Z type joint by means of riveting are flat. In order to make the outer surfaces of the Z type joint and the inner and outer surfaces of the plates flatter, the joining portions of both plates should be processed to become thinner before riveting.

This kind of joint assembly may be applied to side panels of the body of the van trailer. By joining two adjacent sandwich panels through riveting by means of the Z-shaped joint, it is possible to form a side panel of the van trailer with a plurality of sandwich panels. The top end of the side panel made of sandwich panels is riveted to the top beam of the van trailer, and the bottom end of the side panel made of sandwich panels is riveted to the bottom side rail of the van trailer. The front end of the foremost sandwich panel is joined to the front corner post of the van trailer, and the rear end of the rearmost sandwich panel is joined to the rear corner post of the van trailer.

In the van trailer used the Z-shaped joining member according to the present invention, two sandwich panels are joined by means of a Z-shaped joining member so that it is possible to ensure the flatness of the inner and outer surfaces of the side panel made of sandwich panels, and to reduce the payload of the side panel and obtain excellent sealing. In this way, it is not only possible to ensure that the inner and outer surfaces of the entire side panel of the new type joint assembly are flat, but also possible to ensure a relatively large interior width inside the new type joint assembly. The strength and rigidity of the side panel thus joined can meet the design and service requirements for the side panel of van trailer.

In the same time, this kind of joint assembly may be applied to cargo containers as well.

To achieve the aim of the present invention, another new type joint assembly for plates is provided, which is jointed between two adjacent plates and comprises two overlapped joining sections and rivets for securing. Said joining section and said plate are connected by an inclined transitional section to form an integral structure. Between the inner and outer surface plates of the joining section is a core plate. The inner and outer surface plates of the two joining sections are substantially flat with the inner and outer surface plates of the sandwich plates when they are joined. The two joining sections are joined with one or two rows of rivets.

This kind of joint assembly may be applied to side panels of the body of the van trailer. In the van trailer, said joining section and sandwich panel body are of an integrally formed structure. The sum of the thickness of said two joining sections equals to (or less than) the thickness of said single sandwich panel.

The inner and outer surface plates of said side panel sandwich panel are steel plates, and the intermediate core material is multi-laminated plywood, wood board, artificial board, plastic board etc. The metal surface plate and the core plate are bonded by adhesives. The metal surface plate may be steel plate, colored steel plate, galvanized plate, aluminum plate, stainless steel plate, or FRP plate etc. The inner and outer surface plates of the sandwich panel may be any one of the above-mentioned metal plates or a combination of any two of them.

In the van trailer used the joining member according to the present invention, the thickness of the joining section of a single sandwich panel of the carriage body is less than the thickness of the sandwich panel, and the sum of the thickness of said two joining sections equals to (or less than) the thickness of said single sandwich panel. In this way, it is possible to ensure that the inner and outer surfaces of the sandwich panel are flat when the joining sections of two sandwich panels are overlapped and joined by rivets, and there still exists core plate between the inner and outer surface steel plates of the thinned portions of the joining portions of sandwich panels. In this way, it is possible to form a side panel of the van trailer by joining a plurality of sandwich panels. The strength and rigidity of the joined sandwich panel side panel can meet the service requirements for side panels of the van trailer.

Because there still exists core plate between the inner and outer surface steel plates of the thinned portions that overlap, it is possible to ensure that the inner and outer surfaces of the entire side panel of the van trailer are flat, and to ensure a relatively large interior width. To join two or more sandwich panels by means of overlapping and riveting according to the present invention can save joining members, reduce the payload of the side panel and obtain excellent sealing.

In the same time, this kind of joint assembly may be applied to cargo containers as well.

### BRIEF DESCRIPTION OF DRAWINGS

FIG. 1 shows the structure of an interior joint element of the joint assembly according to the first embodiment of the present invention;

FIG. 2 shows the structure when the interior joint element shown in FIG. 1 is joined to the plate of the carriage body;

FIG. 3 shows the structure when an exterior joint element of the joint assembly according to the first embodiment of the present invention is joined to the plate of the carriage body;

FIGS. 4 and 5 show the interior and exterior joint elements shown in FIG. 2 and FIG. 3 are joined integrally;

FIG. 6 shows the detachment operation of the joined interior and exterior joint elements;

FIGS. 7, 8 and 9 show the assembling of the interior and exterior joint elements of another kind of structure;

FIGS. 10, 11 and 12 show the assembling of the interior and exterior joint elements having another kind of engaging structure;

FIG. 13 shows the assembling of the T-shaped joint member according to the second embodiment of the present invention;

FIG. 14 shows the assembling of another kind of T-shaped joint member according to the second embodiment of the present invention;

FIG. 15 shows the assembling of the Z-shaped joint member according to the third embodiment of the present invention;

FIG. 16 shows the assembling of another kind of Z-shaped joint member according to the third embodiment of the present invention;

FIG. 17 shows the assembling of the joint assembly according to the fourth embodiment of the present invention;

FIG. 18 shows the assembling of another kind of joint assembly according to the fourth embodiment of the present invention;

FIG. 19 shows the structure of the van trailer in which the joint assembly according to the present invention is adopted.

### DETAILED DESCRIPTION OF THE INVENTION

Embodiment 1:

The basic idea of the joint assembly provided by the present invention is that the joint assembly consists of an interior joint element and an exterior joint element, on each of which detachable engagement structure is formed, so that two plates are joined by engaging the two elements. The two joint elements may be formed by rolling aluminum alloy or steel. The structure of each joint element includes an engaging portion and a wing. The engaging portion is used to engage each other integrally while the wing portion is used for joining the plate of the carriage body. Rivets or clamps may be used as the method of joining thereof. It is possible to join the joint element to the joining edge of the plate of the carriage body before the assembling of the container (or the trailer), so that riveting operation may be conducted during the manufacturing process of the plate to facilitate the joining. When disassembling and reassembling are needed for maintenance purposes, they can easily done without removing the rivets.

A small stripping opening may be formed on the edge of the inner side of the joint assembly so that after the engagement of the two joint elements, the interior and exterior joint elements having a length equal to that of the plate may be detached by inserting screwdrivers into the opening and prying by force, preferably with two screwdrivers prying alternately for the purpose of facilitating the detachment. In assembling, on the contrary, it is only necessary to align the engaging portions of the two joint elements and press down by force to engage the two joint elements integrally.

The surface of the interior element among the two joint elements faces the inner side of the carriage body while the surface of the exterior element faces the outer side of the carriage body. After the two joint elements are shaped by rolling, it is very easy to punch holes on the interior element if necessary. When the punched hole is not in use, it may be stuffed or just left as it is. Sealing gum may be applied to the seam for the purpose of sealing and water proofing when the interior and exterior joint elements are engaged and assembled.

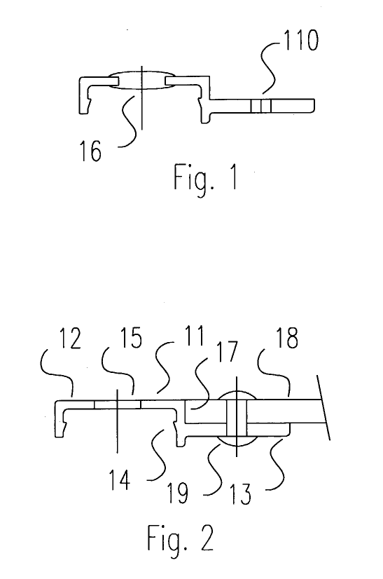

Based on the above-mentioned idea, the present invention provides a structure of the joint assembly and a process of assembling as illustrated in FIGS. 1, 2, 3, 4, and 5. The interior joint element 11, which is located at the inner side of the carriage body when assembled, as shown in FIG. 1, consists of an engaging portion 12 which is of an open rectangular groove shape with an outward opening, the bottom of the groove and a wing 13 which is joined to the plate. The engaging portion 12 is engaged with the exterior joint element integrally through the engaging hook or engaging groove. The wing joining portion 13 is riveted to plate 18 by means of rivets 19. The engaging hook 14 formed on both sides of the engaging groove is triangular. There may be only one hook, and may be a plurality of hooks. A plurality of through holes 15 may be formed for accommodating goods racks. The holes may have different shapes according to different structure of goods racks. If the container (trailer) does not have goods racks, the hole may be covered with a rubber plug as shown in FIG. 2. On the side of the bottom is formed a step 17 which has a depth to enable the inner plane of the plate 18 and the inner plane of the bottom to be on the same plane when plate 18 is riveted. As shown in FIG. 2, punched (drilled) holes 110 are formed on wing joining portion 13 for accommodating rivets 19 to facilitate the riveting between interior joint element and plate 18.

The structure of the exterior joint element of the joint assembly is shown in FIG. 3. The exterior joint element 111 is located at the outer side of the container (trailer) when assembled. The structure of the exterior element consists of an engaging portion which is an open rectangular groove 114 with an inward opening, a wing 113 which is joined to plate 118. Triangular hook or triangular groove for engaging the interior joint element is formed on both sides of the rectangular groove. The engaging portion is engaged with the interior joint element integrally through the engaging hook and engaging groove. The engaging portion is engaged securely with the interior joint element to form an integral part through the engaging hook and engaging groove. The wing joint portion 113 is riveted to plate 118 by means of rivets 119. In order to facilitate the separation of the assembled interior and exterior joint elements, a separating groove 115 may be formed at the corner between the side of the engaging groove and the bottom 112 of the exterior joint element. Detachment can be done by inserting a screwdriver into the separating groove 115 and prying by force to separate the securely engaged interior and exterior joint elements. A small boss 116 is formed on the inner side of the joining wing 113 for covering the edge of plate 118 so as to avoid interference with the groove side of the interior joint element during assembly. The size of the joining wing 113 should be so determined as to enable the inner plane of the plate 118, wing 113 and the inner plane of plate 16 riveted to the joining wing 13 of the interior joint element to be on the same plane after plate 118 is riveted.

When interior joint element 11 is riveted to plate 18, and exterior joint element 111 is riveted to plate 118, they can be secured on the assembly table before riveting so as to ensure the geometrical dimensions and relative position of each plate is within certain form and position tolerance after the plate is riveted to the joint element, to ensure the relative position accuracy in assembling the container and to facilitate the detachment of the plate during maintenance, and also to ensure excellent interchange of each plate joined assembled with a joint element.

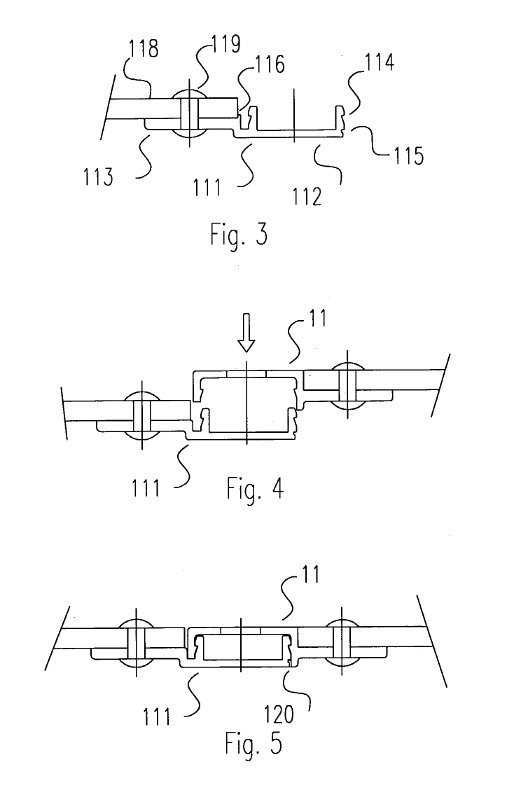

During the assembling of the interior joint element 11 and exterior joint element 111, the hooked groove portions thereof are pressed in the direction of the arrowhead after the upper and lower ends are aligned, so that the groove opening of the interior joint element is expanded due to elasticity while the groove opening of the exterior joint element is constricted due to elasticity, and the bevels of the triangular hooked grooves slide with respect to each other into the respective groove. Thus, the hooked grooves of interior joint element 11 and exterior joint element engage each other integrally as shown in FIG. 5. This structure cannot be destroyed or separated by shock or bending to certain extent.

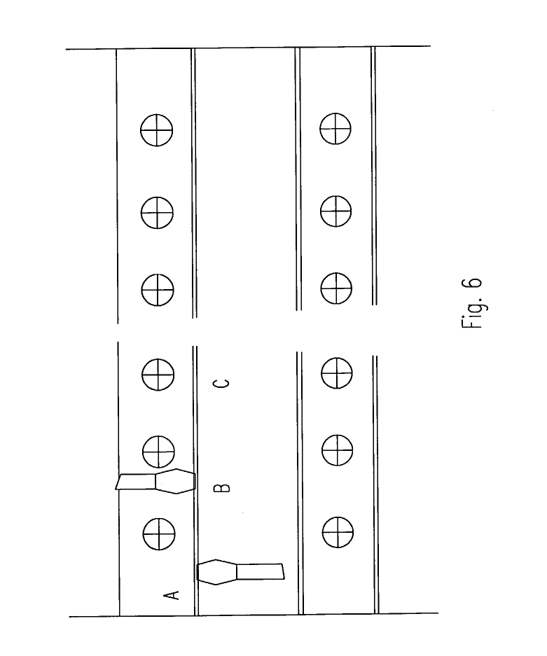

After the interior joint element 11 is engaged with the exterior joint element 11, the separating groove 115 formed on the exterior joint element will form a opening for prying at location 120 after assembly, therefore, when it is required to separate the two joint elements, the separation can be simply done by the operation of two or more screwdrivers at location 120. As shown in FIG. 6, one screwdriver is inserted by force at location A to form an opening so that part of the two joint elements are separated. Then another screwdriver is inserted at location B to pry part of the joint elements in the same way, and then the same operation is conducted at location C and so on and so forth until at last the two engaged joint elements are separated. The detaching process of the interior and exterior joint elements is similar to the detachment of a tyre from wheel-boss.

For the purpose of water proofing and keeping a good outlook, the opening may be stuffed with rubber strip. The rubber strip can be pulled out portion by portion before detaching the two elements in the above-mentioned way. As the rubber strip is elastic, normally it will not fall out by itself.

In the above-mentioned structure, if separate groove 115 is not formed, detachment may be done by drilling at a plurality of locations at the seam between the two joint elements and then prying with screwdrivers.

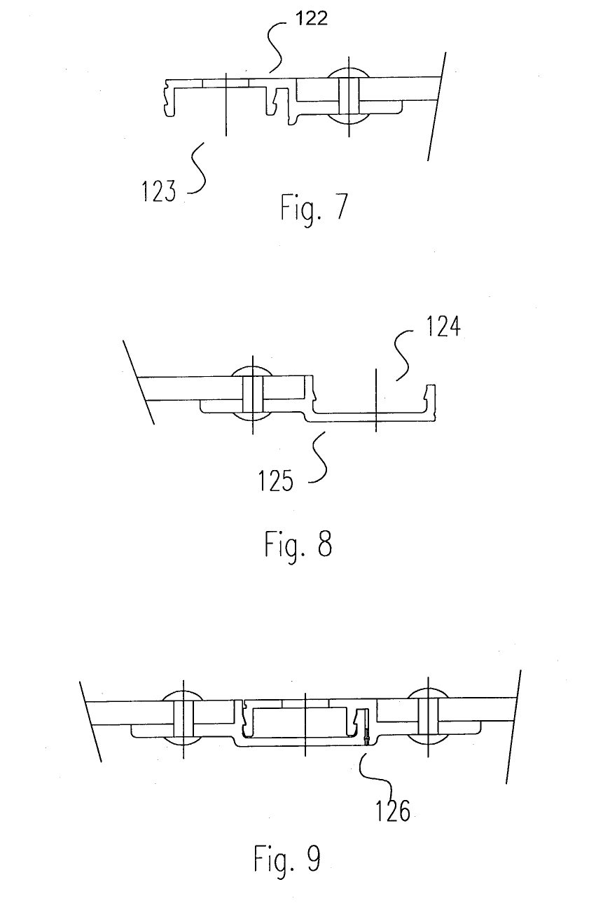

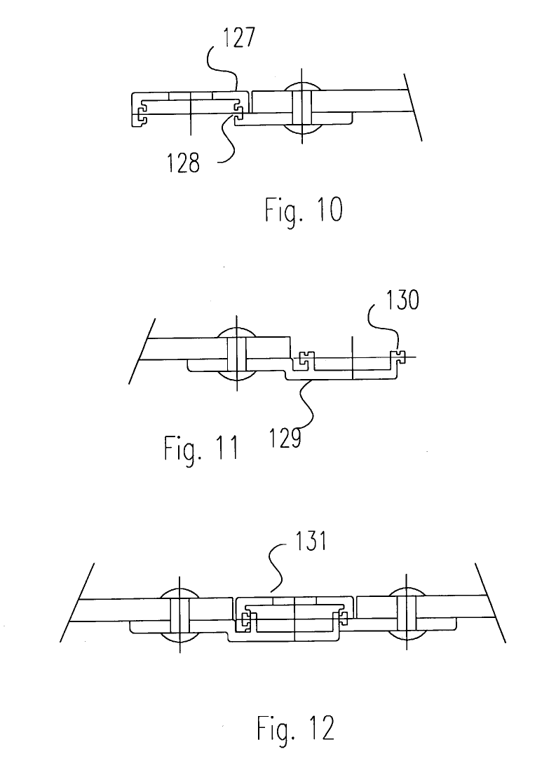

FIGS. 7, 8 and 9 show another method for assembling the interior and exterior joint elements, in which the exterior joint element 122 originally assembled to the outer side of the carriage body is assembled to the inner side of the carriage body, while the interior joint element 124 originally assembled to the inner side of the carriage body is assembled to the outer side of the carriage body. The method for assembling is identical to the above method, so further descriptions are omitted except that the shape of the sealing rubber strip 126 may be different with respect to different shape of the opening for prying.

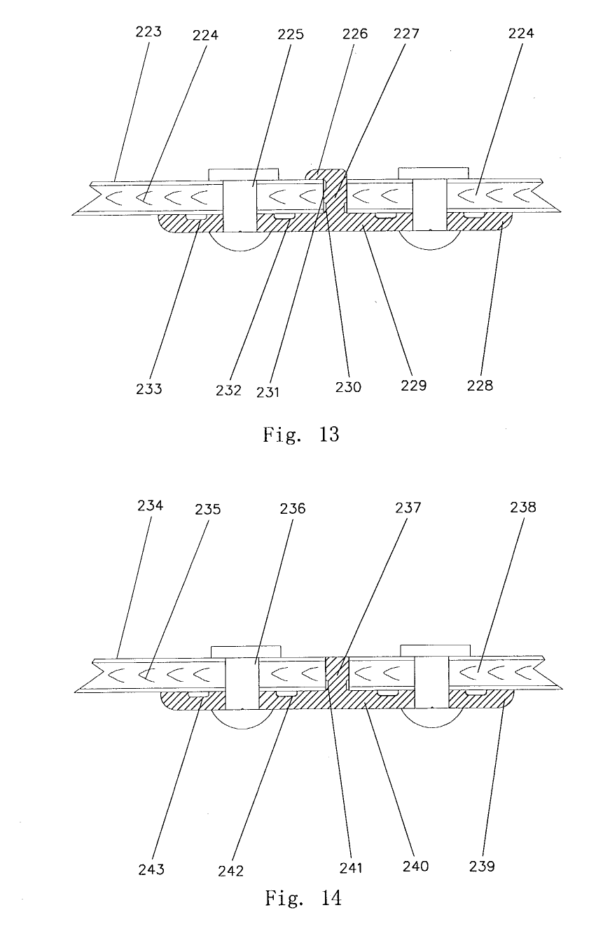

FIGS. 10, 11 and 12 show another embodiment of the engaging structure of the interior and exterior joint elements in the joint assembly provided by the present invention, in which the triangular hooked groove of the engaging portion of the interior joint element 127 is a T-shaped hook or T-shaped groove 128, while the triangular hooked groove of the engaging portion of the exterior joint element 129 is a T-shaped hook or T-shaped groove 130. Joint assembly having such a structure are inserted into each other from top or bottom during assembling. Detachment is done in a contrary way. The assembled structure is shown by the joint assembly 131 in FIG. 12.

According to the joint assembly provided by the present invention, the wings of the interior and exterior joint elements are riveted securely to the joining edges of plates respectively during the manufacturing process of the plates of the carriage body. At the assembling site of the container, by inserting the inserting grooves of the interior and exterior joint elements joined to two adjacent plates into each other, the adjacent plates are joined integrally through the engaging structure of the interior and exterior joint elements. Therefore, the assembling process is convenient and time saving. When the carriage body is to be disassembled for the purpose of maintenance and repair, plates can be detached by separating the interior and exterior joint elements with screwdrivers. Therefore, maintenance and repair are convenient.

Embodiment 2:

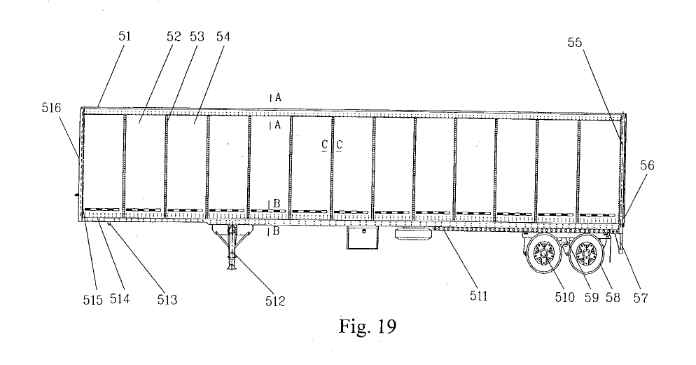

FIG. 19 shows a van trailer having side panels structured by sandwich panels. It consists of top assembly 51, floor 514, front end panel 516, rear door end 56, side panels 52(on both right and left sides), and the body of the van trailer consisting of trailer supporting leg 512, kingpin 513, suspended fender 59, axle 510, tyre 58, and rear fender-guard 57 etc. Each side panel is formed by two or more sandwich panels 52 and 54 joined by means of the T type joint for sandwich panels. The two surface plates of the side panel sandwich panel are made of steel plate, and the intermediate core material is multi-laminated plywood or wood board, artificial board, plastic board etc. The metal surface plate and the core plate are bonded by adhesives. The metal surface plate may be steel plate, colored steel plate, galvanized plate, aluminum plate, stainless steel plate, or FRP plate etc. The inner and outer surface plates of the sandwich panel may be any one of the above-mentioned metal plates or a combination of any two of the above-mentioned metal plates.

FIG. 13 illustrates the sandwich panels in the side panel of the body of van trailer are riveted by means of an intermediate joining member. Two sandwich panels 224 having the same thickness are joined through the T-shaped joining member 229 by means of two rows of rivets 225. The T-shaped joining member 229 mainly consists of a major wing 228, a vertical web 227, and a turned section minor wing 226 which is perpendicular to the end of the vertical web 227. The inner surface of the major wing 228 abuts the outer surface steel plate of the sandwich panel 224. The distance between the inner side of the major wing 228 and the inner side of the turned section minor wing 226 is corresponding to the thickness of the sandwich panel 224, ensuring that the sandwich panel 224 can be inserted into the space smoothly. The length of the turned section minor wing 226 should be limited, corresponding to the thickness of the sandwich panel. The major wing 228 has a certain thickness and width so that when two sandwich panels 224 and the major wing 228 are riveted by means of two rows of rivets 225, the entire T-shaped joining member 229 has the same sufficient flexural strength and rigidity. Two recesses 230 are formed on the body of the vertical web 227 at the right-angle turning portions of the vertical web 227 respectively. In this way, it is possible to ensure the tight contact between the end surface of the sandwich panel 224 and the intermediate surface 231 of the vertical web 227 even if the edge of the sandwich panel is not processed. Recesses 232, 233 are formed on the inner surface of the major wing 228. When the major wing 228 and the sandwich panel 224 are riveted with sealing gum applied to the rivets 225, the recesses 232, 33 may accommodate the gum squeezed out by riveting pressure so that the tightness and reliability of the sealing are ensured.

In the above-mentioned body structure, the inner and outer surface plates 223 of the sandwich panel are metal plates, the planar core is multi-laminated plywood. The inner and outer surface plates 223 and the core plate 224 are bonded by adhesives. The metal surface plate may be steel plate, colored steel plate, galvanized plate, aluminum plate, stainless steel plate, or FRP plate etc. The inner and outer surface plates of the sandwich panel may be any one of the above-mentioned metal plates or a combination of any two of the above-mentioned metal plates. The intermediate core material is multi-laminated plywood or wood board, artificial board, plastic board etc.

To manufacture side panels of the body of van trailer by joining sandwich panels by means of the T-shaped joint 229 can ensure the flatness of the inner and outer sandwich panels of the entire side panel of the body of the van trailer except the thickness of the rivet heads and that of the major wing 229, and obtain excellent sealing effect. This joining member may be made of aluminum, aluminum alloy or steel, plastics by molding.

FIG. 14 shows another kind of T-shaped joining member for sandwich panels in the side panel of the body of the van trailer.

As compared with the joining member in FIG. 13, the present joining member has only vertical web 237 and major wing 239 but no turning section minor wing 226. This member can make the detachment of the sandwich panels easier and more convenient. At the same time, as turning section minor wing 226 is omitted, complete flatness of the inner side panel of the body of the semi-trailer is realized in the real sense.

The side panel of the body of the semi-trailer using joining members of this structure can ensure sufficient interior width of the body of the semi-trailer, and flatness of the inner and outer surfaces after the sandwich panels of the side panel are joined, and effectively increase the strength and rigidity of the entire side panel of the body of of the semi-trailer. The payload of the side panel is light. It is easy to assemble and maintain. The sealing is excellent. The joining member for sandwich panels provided by the present invention can also be used to joining side panel sandwich panels of cargo containers.

Embodiment 3:

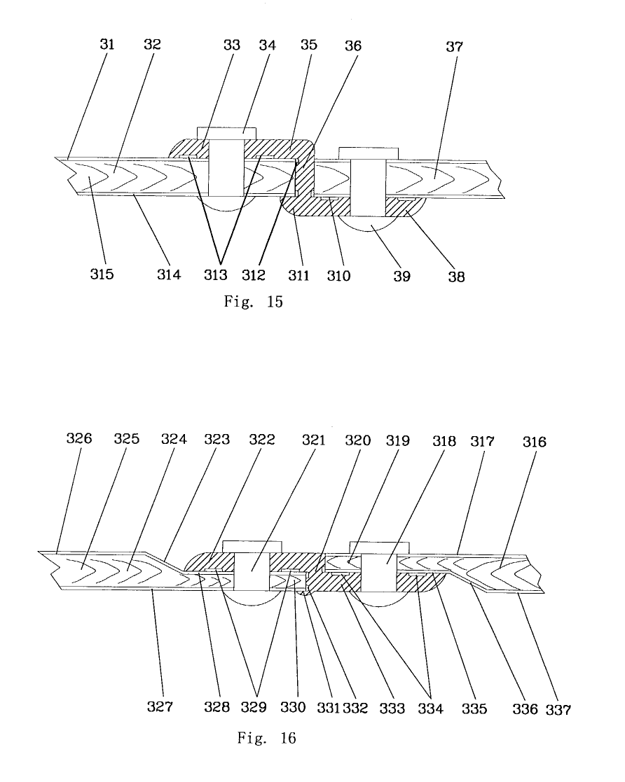

FIG. 15 is a sectional view of the Z-shaped joining member for joining sandwich panels in the body of van trailer. The Z-shaped joining member 35 consists of an inner wing 33, a vertical web 36, an outer wing 38 and a clamping section 311. The inner wing 33 and the outer wing 38 are parallel to each other and perpendicular to vertical web 36. One sandwich panel 32 is positioned between inner wing 33 and claming section 311 with its end surface abutting one side of the vertical web 36. Two recesses 313, 310 are formed on inner and outer wings 33, 38 so that when the Z-shaped joining member is riveted to sandwich panels 32, 37, and sealing gum is applied to the location where the inner and outer wings 33, 38 and sandwich panels 32, 37 contact the rivets 34, 39, the recesses 313, 310 cam accommodate the sealing gum (or gummed tape) squeezed out from the location of the rivets. A small processing recess 312 for facilitating installation is formed at the right-angled corner between the clamping section 311 and vertical web 36, so that it is possible to ensure that the end side of sandwich panel 32 contacts the vertical web 36 tightly even without processing the edge of the sandwich panel 32. In the same way, it is also possible to ensure that the end side of the other sandwich panel 37 contacts the vertical web 36 tightly. When sandwich panels 32, 37 are joined together through the Z-shaped joining member by means of rivets 34, 39, the inner and outer surfaces of the two sandwich panels are flat and even with the outer sides of the inner wing 33 and outer wing 38 positioned on the inner and outer sides of the two sandwich panels respectively.

The joined two sandwich panels 32, 37 have the same thickness (may have different thickness). It is not necessary to process the edges of the two sandwich panels. The inner and outer surface plates 31, 314 are made of metal plates, and the intermediate core material 32, 37 is multi-laminated plywood or plastic plate. The inner and outer surface plates 31, 314 and the core plate 32, 37 are bonded by adhesives. The metal surface plate may be steel plate, colored steel plate, galvanized plate, aluminum plate, stainless steel plate, or FRP plate etc. The inner and outer surface plates of the sandwich panel may be any one of the above-mentioned metal plates or a combination of any two of the above-mentioned metal plates. The intermediate core material is multi-laminated plywood or wood board, artificial board, plastic board etc.

FIG. 16 shows another kind of Z-shaped joining member for joining sandwich panels in the body of van trailer. This Z-shaped joining member is used to join two sandwich panels of the same thickness. A section at the joining portions of sandwich panels 324, 316 respectively is formed to be thinner. In this way, it is possible to ensure that after the inner and outer surfaces of the Z-shaped joining member and the sandwich panels 316, 324 are riveted by rivets 318, 321, the inner and outer surfaces of the side panel are much more flatter. The Z-shaped joining member consists of an inner wing 322, a vertical web 320 (having a height lower than that of the previous web), an outer wing 333 and a clamping section 331. The inner wing 322 and the outer wing 333 are parallel to each other and perpendicular to the vertical web 320. The sandwich panel 324 consists of a main joining section 325, a transition joining section 323 (330) and a joining section 330. The joining sections 330, 319 contact the inner and outer sides of the inner wing 322 and outer wing 333 of the Z-shaped joining member respectively. Recesses 329, 334 can accommodate the sealing gum (gummed tape) squeezed out from the applied locations around the rivets. The small recess 332 is capable of ensuring the tight contact between end sides of sandwich panels 324, 316 and the two outer sides of the vertical web 320 even if the edges of the sandwich panels are not processed. Therefore, reliability and sealing effect are ensured after sandwich panels 324, 316 are riveted to the Z-shaped joining member.

The above-mentioned Z-shaped joining member may be integrally moulded from aluminum alloy, high-strength plastics or steel.

To manufacture side panels of the body of van trailer by joining sandwich panels by means of the Z-shaped joining member can ensure the flatness of the inner and outer surfaces of the side panel sandwich panels after joining, ensure a sufficient interior width in the body of the semi-trailer and the reduction of the payload of the entire side panel, can facilitate assembly and maintenance, and obtain excellent sealing effect. In the meanwhile, this joining method may also be used to join side sandwich panels of the container or sandwich panels for architecture.

Embodiment 4:

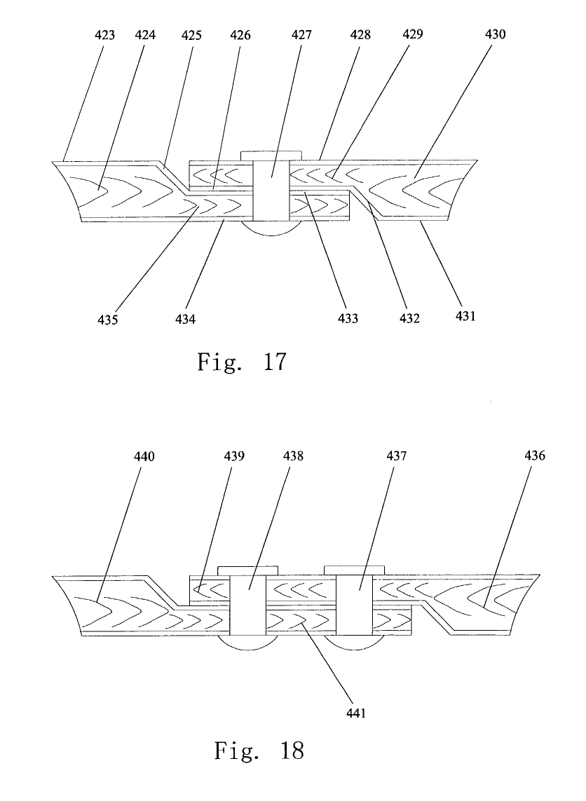

FIG. 17 is a sectional view of an overlapping joining of sandwich panels for side panels of the body of van trailer. The joining portion of the sandwich panel comprises a main section 424, a transitional joining section 425 and a joining section 435. The thickness of the thinned joining section 429 of the joining portion of a single sandwich panel is less than the thickness of the sandwich panel 424. The thickness of the two sandwich panels 424, 430 is equal. The sum of the thickness of said two joining sections 429, 435 when they are overlapped equals to the thickness of the single sandwich panel 423 (430). In this way, it is possible to ensure that the inner and outer surfaces of the sandwich panel are flat when the joining sections of two sandwich panels are overlapped and joined by rivets. The surface steel plate and core plate of the transitional joining section 425 (432) of the sandwich panel form an angle with the main section 424 and joining section 429 respectively. The changed two surfaces of the two thinned joining sections abut each other when they are overlapped and joined, forming an overlapped joining section and are riveted by rivets.

There still exists core wood board between the inner and outer surface steel plates 426, 428 of the joining section 429 of the right sandwich panel. The inner surface steel plate of the left joining section 435 abuts the inner surface steel plate 426 of the right joining section 429. There still exists core wood board between the inner and outer surface steel plates 423, 434 of the joining section 424 of the left sandwich panel. After the joining sections 425 (429) of the left and right sandwich panels are overlapped, rivets 427 are secured through the four steel plates of the two joining sections and the core plates 430, 435 sandwiched between them.

The inner and outer surface plates 423 (434) of the sandwich panel are steel plates, and the intermediate core plates 424 (430) are multi-laminated plywood. The inner and outer surface plates 423 (434) and the core plate 424 are bonded by adhesives. The metal surface plate may be steel plate, colored steel plate, galvanized plate, aluminum plate, stainless steel plate, or FRP plate etc. The inner and outer surface plates of the sandwich panel may be any one of the above-mentioned metal plates or a combination of any two of the above-mentioned metal plates. The intermediate core material is multi-laminated plywood, wood board, artificial board, plastic board etc.

FIG. 18 is a sectional view illustrating another kind of overlapping joining of sandwich panels for side panels of the body of van trailer. The joining section 441 of the left sandwich panel and the joining section 439 of the right sandwich panel are overlapped and joined with two rows of rivets 437, 438. The sum of the thickness of the joining sections 441, 439 when they are overlapped substantially equals to the thickness of the sandwich panel 440 (436). The two rows of rivets 437, 438 are secured through the four steel plates of the left and right two joining sections 439 and 441 and the two core plates sandwiched between them. By joining two sandwich panels having the same thickness, it is possible to ensure that the inner and outer surfaces thereof are flat. This joining method enables the joined sandwich panels to have higher strength, better sealing effect, longer service life and more reliable joining structure.

By making sandwich panel type semi-trailer body side panels by means of the overlapping joining method provided by the present invention, it is possible to ensure that the inner and outer surfaces of the joined side panel sandwich panels are flat, and to ensure a relatively large interior width inside the body of the semi-trailer. It is also possible to save joining members, reduce the payload of the side panel, to facilitate assembly and maintenance, and obtain excellent sealing. Moreover, this overlapping joining method may also be used for joining side panel sandwich panels of cargo containers.

1. A new type joint assembly for plates wherein said joint assembly has a separate type structure consisting of a plurality of joint elements.

2. A new type joint assembly for plates according to claim 1, wherein said joint assembly has a separate type structure consisting of two joint elements.

3. A new type joint assembly for plates according to claim 1 or 2, wherein said joint assembly include interior joint elements and exterior joint elements, said interior joint element has a C-shaped inserting groove opening outwardly, and said exterior joint element has an inserting groove opening inwardly and engaged with the two sides of the inserting groove of said interior joint element, positioning structure engaged with each other is formed on adjacent surfaces on the two sides of the engaged inserting grooves, at least one wing for securely joining the plate of the carriage body is formed on the outer periphery of the sides of said two inserting grooves.

4. A new type joint assembly for plates according to claim 3, wherein said interior and exterior joint elements have a length equal to that of the joining edges of the carriage body plates.

5. A new type joint assembly for plates according to claim 3, wherein the outer sides of both sides of the inserting groove of said exterior joint element is engaged with the inner sides of both sides of the inserting groove of said interior joint element.

6. A new type joint assembly for plates according to claim 3, wherein the inner sides of both sides of the inserting groove of said exterior joint element is engaged with the outer sides of both sides of the inserting groove of said interior joint element.

7. A new type joint assembly for plates according to claim 3, wherein said positioning structure egageable with each other consists of one or more triangular hooks formed on the sides of one of the inserting grooves, and one or more triangular grooves engaged with said triangular hooks formed on both sides of another inserting groove.

8. A new type joint assembly for plates according to claim 3, wherein said positioning structure egageable with each other consists of one or more T-shaped protrusions formed on the sides of one of the inserting grooves and one or more T-shaped concave grooves engaged with said T-shaped protrusions formed on the sides of another inserting groove.

9. A new type joint assembly for plates according to claim 3, wherein a plurality of through holes distributed longitudinally along the bottom of the groove are formed on the bottom of the inserting groove of said interior joint element.

10. A new type joint assembly for plates according to claim 3, wherein a plurality of through holes corresponding to the joining holes on the plate of the carriage body are formed on said wing.

11. A new type joint assembly for plates according to claim 3, wherein a notch for detachment operation is formed at the corner of the outer side of inserting groove sides of said exterior joint element.

12. A new type joint assembly, which is an intermediate joining member having a T-shaped cross section joined between two adjacent plates of the carriage body.

13. A new type joint assembly according to claim 12, wherein said intermediate joining member consists of a major wing, in the middle of the major wing is formed a vertical web to be clamped by the end surfaces of said two adjacent plates, the height of said vertical web is corresponding to the thickness of said plates, the two adjacent plates are riveted to said major wing by rivets respectively, at the end portion of said vertical web is formed a small section of minor wing turning toward one side and engaging the inner side edge of one of the plates

14. A new type joint assembly according to claim 12, wherein said intermediate joining member consists of a major wing, in the middle of the major wing is formed a vertical web abutting the end surfaces of said two adjacent plates, the height of said vertical web is corresponding to the thickness of said plates, the two adjacent plates are riveted to said major wing by rivets respectively.

15. A new type joint assembly according to claim 13 or 14, wherein recesses are formed at the corner between the two sides of said vertical web, and recesses are formed on the abutting surfaces of said major wing and plates.

16. A new type joint assembly according to claim 12 or 13 or 14, wherein the inner and outer surfaces of said plate are metal plates, and the intermediate core plate is one of the following plates: multi-laminated plywood, wood board, artificial board, and plastic board, said inner and outer metal surface plates and core plate are bonded by bonding methods.

17. A new type joint assembly according to claim 16, wherein said inner and outer metal surface plates may be one of the following metal plates: steel plate, colored steel plate, galvanized plate, aluminum plate, stainless steel plate, and FRP plate.

18. A new type joint assembly according to claim 12 or 13 or 14, wherein said intermediate joining member is an integrally moulded metal material member.

19. A new type joint assembly according to claim 12 or 13 or 14, wherein said intermediate joining member is an integrally moulded plastics member.

20. A new type joint assembly, which is an intermediate joining member having a Z-shaped cross section joined between two adjacent plates of the carriage body.

21. A new type joint assembly according to claim 20, wherein said Z-shaped joining member consists of a vertical web, an inner wing and an outer wing connecting respectively to the two sides of said vertical web at right angles, said inner wing contacts and is joined to the inner side of the plate, said outer wing contacts and is joined to the outer side of the other plate, and a clamping section which, together with the inner side of said inner wing, is capable of clamping the end portion of the plate extends from the side of said outer wing.

22. A new type joint assembly according to claim 20, wherein the joining sections of said two adjacent plates are recessed to respectively form a joining section having a thin-walled structure, said Z-shaped joining member consists of a vertical web, an inner wing and an outer wing connected at right angles to the two sides of said vertical web, said inner wing contacts and is joined to the inner side of the joining section of the plate, said outer wing contacts and is joined to the outer side of the joining section of the other plate, and a clamping section which, together with the inner side of said inner wing, is capable of clamping the end portion of the plate is formed at the end of the side of said outer wing.

23. A new type joint assembly according to claim 20 or 21 or 22, wherein the inner and outer surfaces of the carriage body are flat after two adjacent plates are joined by means of the Z-shaped joining member.

24. A new type joint assembly according to claim 20 or 21 or 22, wherein the inner and outer surfaces of the carriage body are substantially flat after two adjacent plates are joined by means of the Z-shaped joining member.

25. A new type joint assembly according to claim 21, wherein a processing recess is formed respectively at the corners formed by the connection of said vertical web and said inner wing and outer wing, a processing recess is formed at the corners formed by the connection of said clamping section and said vertical web, and recesses are formed on the inner sides of said inner wing and outer wing.

26. A new type joint assembly according to any one from claims 20 or 21 or 22, wherein the inner and outer surface plates of said plate are metal plates, the intermediate core material is one from the following plates: multi-laminated plywood, wood board, artificial board, plastic board, said metal plate and the core plate are bonded by adhesives.

27. A new type joint assembly according to claims 25, wherein said inner surface metal plate and outer surface metal plate may be one of the following plates: steel plate, colored steel plate, galvanized plate, aluminum plate, stainless steel plate, and FRP plate.

28. A new type joint assembly according to any one from claims 20 or 21 or 22, wherein said Z-shaped joining member is an integrally moulded member of the following materials: aluminum alloy, high-strength plastics and steel.

29. A new type joint assembly, which is joined between two adjacent plates and comprises two overlapped joining sections and rivets for securing, wherein said joining section and said plate are an integral structure, the overlapped portions of the two adjacent plates in said plurality of plates are thinned, forming a thin plate-shaped joining section respectively, between the inner and outer surface plates of the joining section is a core plate, the inner and outer surface plates of the two joining sections are substantially flat with the inner and outer surface plates of the sandwich plates when they are joined.

30. A new type joint assembly according to claim 29, wherein the sum of the thickness of said two joining sections equals to the thickness of said single plate.

31. A new type joint assembly according to claim 29, wherein the sum of the thickness of said two joining sections is less than the thickness of said single plate.

32. A new type joint assembly according to claim 29 or 30 or 31, wherein said joining section and said sandwich body are connected by an inclined transitional section to form an integral structure.

33. A new type joint assembly according to claim 29, wherein said two joining sections are joined with one row of rivets.

34. A new type joint assembly according to claim 29, wherein said two joining sections are joined with two rows of rivets.

35. A new type joint assembly according to claim 29, wherein the inner and outer surface plates of said side panel plate are steel plates, and the intermediate core material is multi-laminated plywood, the metal surface plate and the core plate are bonded by adhesives.

36. A new type joint assembly according to claim 35, wherein said inner and outer metal surface plates may be one of the following: steel plate, colored steel plate, galvanized plate, aluminum plate, stainless steel plate, and FRP plate.

37. A new type joint assembly according to claim 29, wherein said intermediate core material may be one of the following: multi-laminated plywood, wood board, artificial board, and plastic board.
